(19) United States
(12) Patent Application Publication
(10) Pub. No.: US 2019/0202732 A1
(43) Pub. Date: Jul. 4, 2019

(54) METHOD FOR THE PRODUCTION OF A LAYER OR A PATTERN FOR COATING THE INNER SURFACE OF A RECEPTACLE, AND RECEPTACLE OBTAINED BY A METHOD OF SAID TYPE

(71) Applicant: Glass Surface Technology, Paris (FR)

(72) Inventors: Christophe Wagner, Bussiere-Poitevine (FR); Alexis Marsal, Limoges (FR)

(73) Assignees: Glass Surface Technology, Paris (FR); Glass Surface Technology, Paris (FR)

(21) Appl. No.: 16/302,741

(22) PCT Filed: May 24, 2017
(86) PCT No.: PCT/FR2017/051299

§ 371 Date: Nov. 19, 2018

(30) Foreign Application Priority Data
May 25, 2016 (FR) 1654706

(51) Int. Cl. C03C 17/00; C03C 17/04; B65D 23/02; C09D 183/04

(52) U.S. Cl. CPC C03C 17/009; C03C 17/04; B65D 23/02; C03C 2217/72; C03C 2217/485; C03C 2218/113; C09D 183/04

(57) ABSTRACT

The invention relates to a method for producing a neutral barrier layer for coating the inner surface of a receptacle for holding products that are biocompatible for humans and/or animals, and to the receptacle obtained by said method. According to the invention, a solution is formed that contains at least one solvent, water, at least one complexing molecular alkoxysilane precursor, at least one surfactant, at least one pigment and/or coloring agent, and a catalytic acid, the complexed solution, which is undergoing hydrolysis and condensation, is homogeneously applied to at least one portion of the inner surface of the receptacle, the applied solution is dried at a specific drying temperature such that a layer is formed which is opaque, translucid and/or forms a particular pattern, and the receptacle is conveyed away, stored and filled with the product.

The present invention relates to a process for the manufacture of a layer or of a pattern for coating the internal face of a receptacle.

It also relates to a receptacle obtained with such a process.

The invention has a particularly important although non-exclusive application in the field of the manufacture of glass bottles intended to receive and preserve pharmaceutical or cosmetic products and more particularly in the field of the coloration and/or decoration of bottles for perfumery.

The use of a colored bottle obtained by coloration of the glass in its bulk is already known. The affixing of a coating or pattern layer to the external face of the bottles is also known.

Such solutions exhibit disadvantages of manufacturing cost in particular, tinted glass being more expensive and/or more difficult to shape. For its part, an external coating is also difficult to manufacture and especially more delicate as it is liable to be damaged or torn off, for example by rubbing during the handling thereof.

The field of perfumery furthermore requires the preservation of products containing a high proportion of alcoholic solvent, for example a proportion of greater than 10% by volume, for example greater than 20%, for example greater than 60%, under standard conditions.

In point of fact, such products are combined with plant derivatives, concentrated essences and/or other products having high pH values, which renders them aggressive and produces risks of increased contamination in the long run of the product preserved by interaction with the walls of the bottle.

This is because the storage of fragrance in a glass bottle requires the preservation of products in a neutral way for a fairly long time (for example several months, indeed even years).

Conventionally, neutral glass is understood to mean a glass which, over time, releases ions, for example sodium ions or other alkali metal and/or alkaline earth metal ions, in a very small amount into the liquid or product which is inside the receptacle.

Very small amount is understood to mean a ratio of total weight of the extractable elements to weight of the liquid contained of less than 6 ppm.

Soda-lime glass is not, for example, neutral within the meaning of the Pharmacopeia.

It is thus known that, when a glass bottle is manufactured, it is necessarily brought to high temperatures which result in particular in a migration of the alkali metals (in the case of a silicate glass), which rise to the surface of the glass and/or to its immediate proximity, in a way sufficient to be subsequently exposed to the contents of the receptacle.

In point of fact, the amounts of these substances, of alkali metal or others, although generally very small, are a nuisance in the case of bottles intended to contain cosmetic products or fragrances which will come into contact directly with the skin of the user.

The present invention is targeted at providing a manufacturing process responding better than those previously known to practical requirements, in particular in that it makes it possible to overcome the disadvantages of the prior art and in particular to minimize containers/contents interactions while allowing a marking and a coloration of the walls of the bottle which are esthetic, inexpensive and not very subject to deterioration.

In order to do this, it starts from the idea of carrying out an internal marking of the wall of the receptacle, for example by coloration, this then being protected from external scratches and impacts, thus making it possible to satisfy the high esthetic requirements of the field.

However, on doing this, potentially injurious additional elements are introduced directly into the bottle. Specifically, it is also necessary for the coating not to be liable to degrade in an even more troublesome way than the glass.

In point of fact, the specific composition of the product present, and the chemical nature of the latter (predominantly alcoholic compound combined with concentrated essences, and the like), make it particularly difficult for the layer to hold well and for a low degree of release to be observed.

Processes are known (WO 2010/112792; FR 2 935 594) for covering at least a fraction of an internal face of a receptacle with a vitreous material prepared according to a process known to a person skilled in the art under the term sol-gel (diminutive of solution-gel).

The vitreous material, which is based on silica, is obtained without melting, by polymerization of at least one molecular precursor.

It comprises a synthesis stage carried out starting from alkoxides of formula M(OR)ₙ, where M is a metal, for example zirconium, and R is a CₙH₂ₙ₊₁₌ organic alkyl group, dissolved in a conventional solvent, followed by a more or less lengthy stage of gelling with evaporation of the solvent until solidification is complete.

Such processes exhibit disadvantages.

This is because they leave a residual acidity on the support during the use of the acids conventionally chosen, such as acetic acid or hydrochloric acid, which can modify the olfactory perception of the fragrances.

However, in addition and in particular, these processes have not identified the barrier problem and, for this reason, have not sought and do not make it possible to sufficiently increase the hydrolytic resistance, as generating an excessively porous coating and/or leaving zones which are poorly protected (holes) on the surface part concerned, where the deposition is carried out.

In other words, with such processes, the effectiveness of the function of barrier to releases and to exudation phenomena deteriorates over time with excessively rapid kinetics for the constraints of duration of preservation, in particular for applications in perfumery.

Processes of this type are generally also specifically suited to one type of constituent material of the receptacle.

In point of fact, this is particularly problematic when it is desired to functionalize the layer, that is to say to add to it chemical elements which make possible the expression of a specific function, such as: coloring of the layer, resistance to electromagnetic radiation, medical functions, in particular antibiotic functions, specific visual effects, or any other function.

These elements are then either released or do not completely fulfill their function and damage the hold of the layer, to the detriment of its barrier capacity.

To sum up, it is observed in particular that these processes, using strong acids such as hydrochloric acid (HCl), which are naturally favored by a person skilled in the art for the preparation of reactive solutions and the increase in the kinetics of the reaction, on the one hand exhibit the disadvantage of allowing the passage of a residual amount of acid which in the long run disturbs the quality and the odor of the fragrance and, on the other hand, do not optimally provide a barrier with regard to the wall of the receptacle, resulting in releases into the product present.

The present invention makes it possible to overcome these disadvantages, in particular in that it makes it possible to treat all types of bottles with the same formulation, independently of the suppliers of these, and while generating less breakage or damage of the receptacles than in the prior art, in that it significantly improves the hydrolytic resistances by generating a true barrier effect and good neutrality, that is to say an impermeability to the products which can be extracted from the wall of the receptacle, in that it optimizes the attachment of the layer to the internal wall of the receptacle, in that it makes it possible to functionalize the layer without doing it to the detriment of the hydrolytic resistances, mechanical strengths, thermal resistances and chemical resistances of the layer and in that it makes it possible to operate in a confined environment with, for example, application by a sprayer.

The invention also makes it possible to obtain set layers with a greater and more uniform thickness and with good reaction kinetics at the industrial level for treatment temperatures which are generally lower than in the prior art.

With the invention, the final esthetic result of the layer is improved by significantly reducing the cracks and dents of the layer, this being done in a lasting manner over time, which is crucial in the field of luxury goods and of perfumery.

To sum up, the invention makes it possible to obtain a layer which provides a neutral barrier which is impermeable to radiation and to chemical entities, in both directions of traversal of the layer.

It is thus in particular an object of the present invention to employ these principles with the above-mentioned advantages.

With this aim, it provides in particular a process for the manufacture of a neutral and barrier layer with an inorganic matrix for coating the internal face of a receptacle suitable for containing products biocompatible with man and/or animals, in which:
a solution containing at least one solvent, water, at least one complexing molecular precursor of the family of the alkoxysilanes, at least one surfactant, at least one pigment and/or dye and citric acid as catalyst is formed,
the solution thus complexed is uniformly applied to at least a part of the internal face of the receptacle, the solution being in the course of hydrolysis and condensation, and
the solution thus applied is dried at a predetermined drying temperature in order to form, on said internal face, said barrier layer, which is opaque, translucent and/or forms a predetermined pattern, before evacuation, optional storage and then filling of said receptacle with the product.

In particular, there is thus no subsequent treatment necessary for the good preservation of the product.

Solvent is understood to mean a substance other than water which has the property of dissolving, diluting or extracting other substances without chemically modifying them and without itself being modified.

Manufacture of a barrier layer for coating the internal face of a receptacle is understood to mean the manufacture of a covering solution which forms, after gelling and then solidification, a layer of protective material, and also the covering proper, that is to say the surface affixing of such a solution to the surface of an object formed of another material, in order to create, after gelling and curing, this protective layer in an integral and lasting way (that is to say, greater than several years).

More specifically, a better barrier effect is observed when the hydrolytic resistance during successive measurements is on average better than with the prior art by at least ten percent, advantageously 30%, indeed even 50% and up to 80% (and thus the capacity for release, which is proportional to it).

Such a coating modifies the physical and/or chemical surface properties of this other material (when it comes into contact with a product).

Layer of inorganic matrix is understood to mean a layer not comprising organic compounds, except for what would be optional additives.

In the course of hydrolysis and condensation is understood to mean the fact that the overall chemical reaction has not yet reached its final or maximum degree of progression.

It is known that the degree of progression ξᵣ of a reaction is defined by

$${ξ}_{r} = \frac{ξ}{ξ max}$$

with ξᵣ∈[0;1] and
ξ: degree of progression at the given instant t
ξₘₐₓ: final or maximum degree of progression.

Furthermore, the progression of the reaction is defined by

$$d ξ = \frac{dni}{vi}$$

with
dnᵢ: variation in the number of moles from the initial instant and
νi: stoichiometric number of the reaction.

In the case in point, the degree of progression has to be at a value of less than 1, making possible the micro spraying.

Alternatively, in the course of hydrolysis and condensation is also understood to mean that the solution in the course of gelling has, at the instant t, a viscosity which makes possible a homogeneous application, for example a dynamic viscosity at 20° C. of between 1 and 150, for example between 3 and 80, and in particular of less than 50 mPa·s, for example of less than 20 mPa·s, for example of less than 10 mPa·s.

This is because the progression of the reaction and the viscosity are related.

The density of the layer and also the possibility for the latter of being formed of a single closed surface (2 dimensions) devoid of holes, i.e. of 0 genus in topology, further increases the resistance to release of the internal surface of the bottle.

It should be noted that the surfactant can be initially incorporated in the pigment and/or dye but that both the surfactant and the dye (or the pigment) are incorporated in the sol-gel, that is to say in the body of the latter, and not simply present at and/or bonded to the surface of the latter.

Finally, the final stage of drying at a predetermined temperature advantageously takes place immediately after the application of the solution.

Immediately is understood to mean straightaway or within the few minutes which follow (<60 min).

It is this drying stage which definitively forms the hard barrier layer according to the embodiment of the invention more particularly described here and which will be used as is, after optional storage, to be filled by the perfumer.

No other process stage, such as heating or chemical treatment, is thus necessary for the designed operation of the coating in contact with the product after this drying stage before the filling.

With the invention, it will thus be possible to carry out a colored internal marking by a protective layer of high hydrolytic resistance, essentially on glass but without necessarily excluding plastic, and with, on the one hand, an enhanced esthetic quality (absence of grain, homogeneity of the smear-free layer, even for high thicknesses), and for a hold (that is to say, an attaching to the wall of the receptacle) which is optimized over time.

Despite the continual process of gelling/solidification, it is also possible to preserve, over the long term, the gel (partially gelled solution) produced from the above solution and to operate at ambient temperature.

With the invention, the release of ions by the receptacle over the covered surfaces is considerably reduced. In other words, the ability of a receptacle, the internal face of which is substantially entirely covered, to withstand the release of elements is improved (better barrier effect).

Such a result is obtained without subsequent treatment and under appropriate storage conditions, the measurements being carried out, for example, via the determination methods provided by the standard ISO 4802-2 or by titration according to the standard ISO 4802-1.

Conventionally, the hydrolytic resistance is measured before treatment and after treatment by determination of the amount of sodium oxide and of other alkali metal or alkaline earth metal oxides released during a treatment in an autoclave at 121° C. for 60 minutes, the measurements being, for example, subsequently carried out in a way known per se by flame spectrometry.

With the invention, it is thus found that subsequent releases, in particular as tested in standardized fashion in an autoclave or other as described above, thus no longer make it possible to measure significant degrees of release.

In advantageous embodiments, recourse is had, otherwise and/or in addition, to one and/or other of the following arrangements:
the receptacle being made of glass, the predetermined drying temperature is between 140° C. and 220° C.;
the solution thus applied is dried by increasing the temperature at a rate of between 1° C.·min⁻¹ and 10° C.·min⁻¹ up to the predetermined drying temperature;
the coating is dried by placing the bottle directly at the drying temperature (for example 150° C.) in order to set the coating;
the receptacle is preheated to a second temperature lower than the predetermined drying temperature before application of the solution;
the second temperature is between 70° C. and 90° C.;
the drying at a predetermined drying temperature comprises a first stage of predrying at a third temperature lower than the drying temperature for a predetermined time, followed, advantageously immediately, by a second stage of drying at the predetermined temperature.

This predrying stage, for example at 25° C. for one hour, makes it possible to certainly evacuate all of the solvents at low temperature (<30° C.). This makes it possible to avoid, in some cases, bringing said solvents, for example present in the sol-gel and/or the pigments, suddenly to boiling point, which would then risk damaging the barrier layer.
the third drying temperature is between 20° C. and 50° C.;
the molecular precursor is taken from tetraethyl orthosilicate and trimethoxymethysilane;
the solvent comprises butoxyethanol and/or ethanol;
the pigment is taken from metal oxides comprising cobalt and titanium, metal oxides comprising copper and chromium, or photochromic pigments and/or the dye is taken from the families of compounds comprising, alone or in combination, Pyrisma™, Iriodin™, quinacridone, phthalocyanine, quinophthalone and/or the compounds formed of a layer of aluminum and/or its oxides, micas, said layer being itself coated with a layer of silicon oxide.

The micas are, for example, muscovites (aluminum hydroxyl silicate), which make possible metallic effects.

Pyrisma™ and Iriodin™ are registered trade marks of Merck. They are powdered products containing mica, TiO₂ (rutile), namely from 29 to 48% in Iriodin™ and from 57% to 67% in Pyrisma™ and SnO₂ (1-25μ);
compounds taken from the families comprising colloidal nanosilver particles and/or titanium oxides and/or cerium oxides and/or carbon black and/or polydimethylsiloxane are added to the solution before application to the internal face of the receptacle;
the solution is formed by mixing the solvent in part and the precursor or precursors (for, for example, 5 min and up to 20 min), then aqueous acid solution is added and then the pigments (for example after 1 min) and/or the dye is/are added, and the mixture obtained is exposed to a mechanical ultrasound wave for a predetermined time (for example of between 10 min and 20 min, for example 15 min).

Advantageously, surfactants mixed with the remainder of the solvent on its own (0.1 g in 3 ml of solvent in proportion, for example) are added to the preceding solution. The combination is then subjected to ultrasound for at least one pass, for example for 5 min, before mixing for several hours, for example 4 h.

Advantageously, the size of the pigments has to be less than 25 microns, and of nanometric size for the case of cerium, in order to block the UV radiation without changing the appearance of the coating. For greater pigment sizes, a vibration is used on our application point in order to make it possible to apply these “bulky” pigments, and also a preheating which makes it possible to instantaneously fix the layer to the wall, as below.
before application of the solution to the internal face of the receptacle, the extractable substances are extracted beforehand from said internal face by treatment in an oven in a humid atmosphere containing molecules of sodium chloride and/or of calcium gluconate dissolved in water in proportions not exceeding those which make possible complete dissolution of said molecules;
the surfactant is taken from cetrimonium bromide, anionic surfactants or sodium lauryl sulfate and/or silicone is added;
the surfactant is taken from polyethylene glycols with a molar mass of between 1000 and 2000 g·mol⁻¹, polyethylene glycol tert-octylphenyl ether (known under the name Triton X-100 from Thermo Fisher), polyethylene glycol, polyethylene glycol p-(1,1,3,3-tetramethyl-butyl)phenyl ether.

The silicone, in particular such as polydimethylsiloxane, is not really a surfactant but can in fact be an additive for strengthening the layer.

The inorganic coating according to the invention also makes it possible to deposit and protect a first colored coating layer made of glass substance applied to the internal surface of the colorless glass (by fusion of powder or of liquid, and the like) and to prevent the colored pigments of the glass from passing into the fragrance.

The invention also provides a receptacle obtained by the process or processes described above.

It also relates to a receptacle, the internal face of which is covered, at least in part, with a complexed and dried gelled solution containing at least one solvent, water, at least one complexing molecular precursor of the family of the alkoxysilanes, at least one surfactant, at least one pigment and/or dye and citric acid as catalyst.

The proportions are then advantageously of the following type.

Per 100 ml of preparation mixture before the pigments, from 50 to 64 parts of solvent, including up to 50% of ethanol and from 50% to 100% of butoxyethanol, are introduced, which are mixed with from 18 to 27 parts of precursors and from 18 to 24 ml of aqueous acid solution, including from 16 to 22 ml of water and from 1.9 to 2.6 ml of acid.

Finally, per 100 ml of this mixture, from 2.5 to 32 g of pigments or fillers and from 0.01 to 2 g of surfactants are added.

In an advantageous embodiment, the gelled solution forms a decorative pattern in contrast to the adjoining internal surface.

Advantageously, the receptacle is a cosmetic or fragrance bottle made of glass.

In another embodiment, the receptacle is made of transparent plastic.

A better understanding of the invention will be obtained on reading the description which follows of embodiments described below as nonlimiting examples and with reference to the figures which accompany it, in which:

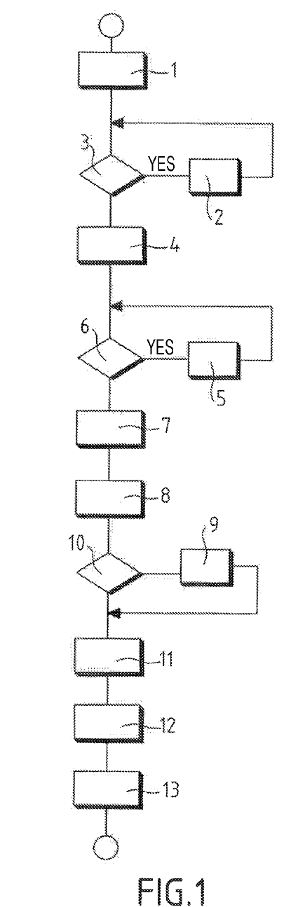

FIG. 1 is a flow diagram showing the stages of a process for the manufacture of a coating layer according to an embodiment of the invention.

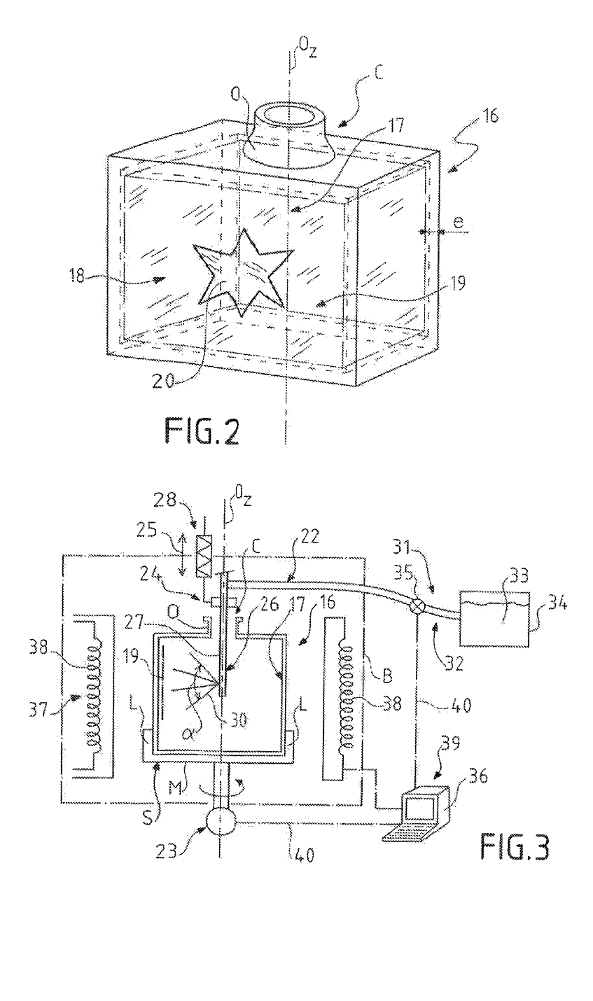

FIG. 2 shows, in perspective, a receptacle according to an embodiment of the invention.

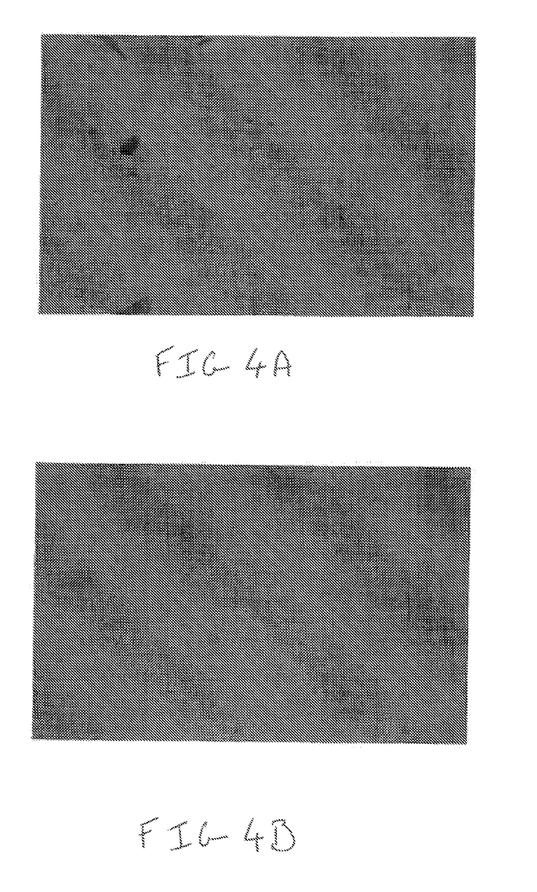

FIG. 3 diagrammatically shows, in section, an embodiment of a device implementing the process according to an embodiment of the invention.

FIGS. 4A and 4B respectively show, with a microscope, the surface of a sol-gel layer without surfactant and the surface of a sol-gel layer with surfactant according to the invention.

FIG. 1 is a flow diagram giving the main stages of the process for the manufacture of the barrier and functional inorganic layer (apart from the additives) according to the embodiment of the invention more particularly described here.

The process makes possible the high attachment to the surface of the internal face and the dispersion of the pigments and/or dyes in the layer.

In the case of some pigments, the spraying is additionally carried out by vibrating the spraying equipment and the drying stage can include a first treatment from 30 to 50° C. which will make it possible to evaporate the solvents and/or preservatives of the pigments, for example a confined environment, in order to prevent ingestion of the molecules of the solvent by the operators.

After supplying the glass bottle, for example made of transparent glass conventionally used for fragrance bottles, for example of parallelepipedal shape and with a mean sidewall thickness of 4 mm and a mean bottom wall thickness of 10 mm, the sol-gel solution is prepared according to the following method.

The addition is carried out, to a perfectly clean (rinsed with solvent and dried beforehand) preparation tank and after determination of the proportions, which will depend on the result which it is desired to obtain and which will be further specified below, of one or more molecular precursors of the family of the alkoxysilanes (stage 1), then one or more solvents (stage 2), according to the results of the test 3 for choosing of optional additional solvent(s), then the aqueous acid solution (stage 4) and then one or more pigments and/or dyes (stage 5), according to the results of the test 6 for choosing optional additional dyes, a stage 7 of mixing by ultrasound, followed by an addition of surfactant in solvent (stage 8), followed by at least one mixing by ultrasound (stage 9), according to the result of the test 10 on the number of stirring operations, followed by the mixing proper (stage 11) with a stirrer, for example for 4 h. One or more surfactants according to the results of the test 7 for choosing of optional additional surfactants can also be added in stage 6.

Advantageously, the solid pigments are thus subjected to ultrasound with the solvent (for example butoxyethanol) and/or the surfactants, when they are in a small amount (less than 1 g), but before the addition of the molecular precursor, for example tetraethyl orthosilicate (TEOS). This makes it possible to improve the dispersion of the pigments and surfactant(s) in the body of the gel. Likewise, the complete preparation containing solid pigments is subjected to ultrasound alternating with mixing stages in order to promote the dispersion without forming a paste in the case of prolonged use of ultrasound.

It should be remembered that all of the different additions are carried out with mixing, for example using a magnetic stirrer.

In the method described with reference to FIG. 1, the catalyst (acid) is added to the mixture thus obtained in stage 4, which more particularly promotes the hydrolysis and the condensation of the sol-gel solution.

Advantageously, the bottle is preheated, for example parallel to the preparation of the solution carried out in stages 1 to 11.

The solution thus complexed is then applied (stage 12) to the internal face, completely or according to the pattern chosen, before drying and evacuation (stage 13).

The only following stage will be, according to the embodiment of the invention more particularly described, the filling of the bottles in order to package them for marketing.

In other words, no other chemical or heat treatment is subsequently applied to the bottle before it is filled.

There is thus no need for a heat treatment in order for the coating according to the invention to perform its role.

On the other hand, bringing to temperature in order to add another decoration which would not have been produced before is possible for the coating, if it does not exceed the temperature of hold of the sol-gel used in the process.

According to the embodiments of the invention more particularly described, the proportions per 100% by volume, for example per 100 ml, of the solution appropriate for being applied are, as has been seen, and for example included within the following ranges:

water: 16 to 22 ml
acid: 1.9 to 2.6 ml
solvent(s): 47 to 70 parts
precursor(s): 12 to 30 parts
to which are added, by weight, for these 100 ml,
surfactant(s): 0 to 2 g
pigment(s) or dye(s): 2.5 g to 32 g
the drying temperatures being between 140° C. and 220° C. with a rise in temperature with stationary phases (for example two stationary phases, the first of which, for example, of 30° C. and 50° C.) and/or gradually, for example at a rate of between 2° C./min and 15° C./min, for example 10° C./min.

Jointly or alternatively, an optional preheating of the bottle (without solution) between 50° C. and 100° C., for example between 70° C. and 90° C., for example at 80° C., is provided.

A fragrance bottle 16 has been represented in perspective in FIG. 2, which bottle comprises, on the internal face 17 of its wall 18 with a thickness e, for example, of a few nanometers or of a few microns with the large pigments, a colored (contrasting) coating 19 and additionally comprises a star-shaped decorative pattern (pigment), both successively affixed with two different successive solutions according to the invention.

The solution is advantageously applied by spraying, as will more particularly be described with reference to FIG. 3.

Depending on the pigments, different surfactants and dispersants are also added in order to improve the deposition and the dispersion of the pigments.

Generally, pigments with a size of less than 10 microns are more suitable for the mixture and for the dispersion. If they are too large, they have a tendency to carry the pigments toward the bottom of the bottle after spraying. This phenomenon can be compensated for in part by preheating the bottle before deposition, which sets it in the application.

Likewise, hydrophobic pigments are better dispersed and held by the sol-gel matrix.

Selective examples of the pigments used are:
Ceramic and inorganic pigments, special effect pigments: they make possible good chemical resistance and an undisturbed spraying process.
Special effect dyes: in particular, those from Merck, such as Pyrisma T81-23 and Iriodin 111 (<15 microns) and 6123.
Small-sized organic dyes having a high coloring power (transparency): these dyes are chosen because they are included on the list of pigments allowed in cosmetics, with a high coloring power (important because the film obtained with the invention is thin (<50μ)), no grains or agglomerates and good persistence of color (light, chemical resistance). On the other hand, due to their small size, they are relatively soluble in an aqueous medium but resistant in an alcoholic medium (fragrance, and the like).
Quinacridone (pink, magenta): the objective here is to provide an organic pigment in cosmetics which holds with fragrances/cosmetics, while making possible a transparent coating, without trace of grains (pigments).
Copper phthalocyanine (blue, green): this is an organic pigment allowed in cosmetics which holds with fragrances/cosmetics and which makes it possible to produce a transparent coating. Triton™ X100 from Thermo Fisher, added to aqueous acid solution+pigment+ultrasound+butoxy+TEOS, is a good implementational example.
Quinophthalone: for example, with the formula butoxy+PEG+pigment+ultrasound 3 passes and 7 ml of acid+TEOS, then mixing of the two, stirring 3 h.

Advantageously, the solution according to one embodiment of the invention provides functional additives, all dispersing well because they are small in size, such as, for example:
antibacterial silver colloids
opacifying white TiO₂
CeO₂ for blocking UV radiation
carbon black.

As has been seen, the heating cycles can be modified in order to better prepare the surface. The bottles can thus be preheated in order to make it possible to better set the sol-gel on the surface. Likewise, a prior extraction can be carried out in order to enhance the attachment and the resistance of the layer.

Moreover, a replacement of the TEOS or addition of trimethoxymethylsilane (TMS) makes possible a better attachment and a better hold in heat treatments and is advantageous in further improving the hold and the attachment of the silica of the layer and of the pigments, in particular in the case of mechanical rubbing (fragrance pump dip tube, for example).

In this instance, the following preparations prove to be particularly effective (the abbreviation buto is for the solvent butoxyethanol): 14 ml of buto+4 ml of TEOS+4 ml of aqueous acid solution (preparation 4 g of citric acid dissolved in 20 ml of R1 water)+1.2 g of quinacridone pigment+0.05 g of PEG 1500 dissolved in 3 ml of butoxyethanol mixed as above and dried at 200° C. for 1 h.

Furthermore, it is found that, by the addition of a solvent combination for controlling the curing and the attachment of the layer, the esthetic quality of the coating is improved. This is because, by adding ethanol to the formula with pigments (at a proportion of 43%), the gradual evaporation of the solvents is made possible because the evaporation temperature of ethanol is 78° C. and that of butoxyethanol 171° C.

During the rise in temperature, the ethanol evaporates first, followed by the butoxyethanol. With the two solvents, the results of hold and of deposition on rectangular bottles are consequently improved in some cases.

It is thus noted that, on drying the coating at 150° C. directly with rapid rise in temperature (bottles placed in an oven at 150° C. directly), this makes it possible to set the coating and to increase the amount of coating placed in the bottle.

Finally, there is an improvement in the attachment in the event of addition/replacement of the TEOS by 1,2-bis(triethoxysilyl) ethane, dipodal silane, and/or silane (octadecyltrimethoxysilane). This is because it is observed that the silanes make possible better attachment to plastics and glasses.

Several implementational examples of the invention have now been represented below, which examples make possible excellent results with regard to the appearance obtained (absence of cracks, excellent resistance to aging without deterioration, no appearance of nonhomogeneous regions) with addition of surfactant, which further improve the very good results obtained with example 1 (comprising traces of surfactant).

### EXAMPLE 1

Black bottle with mixture of 2 “liquid” pigments (comprising traces of surfactant, i.e. between 0.02 g and 0.2 g of PEG) added at 2 different stages, also containing solvents evaporated with the low-temperature stationary phase.

Test 1 comprising 5 g of opaque black pigment+9 ml of butoxyethanol+4 ml of TEOS+the 4 ml of acid (4 g+20 ml) and 6 g of a second pigment added after mixing for 17 h.

The 9 ml of buto and the 4 ml of TEOS are introduced into a beaker, stirring is carried out for 5 min, the aqueous acid solution is then introduced, 1 min later the opaque black pigment is mixed, stirring is carried out for 12 h, then 6 g of the second pigment are introduced, followed by a second stirring.

Two black pigments are thus provided, one of which added in the morning, in order to allow the first pigment to disperse and to increase the coloring by a 2^{nd} pigment.

The drying is carried out with a stationary phase at 35° C. (range from 30 to 50° C.), in order to evacuate the low-boiling-point solvent, and then at 150° C. for 1 h.

### EXAMPLE 2: DRY PIGMENTS WITH ADDITIONS OF SURFACTANTS

Test 2 (14 ml of buto+0.05 g of PEG+1.2 g of quinacridone rose+4 ml of TEOS+4 ml of acid (4 g+20 ml).

NB: buto=butoxyethanol.

### Preparation:

11 ml of buto+4 ml of TEOS are introduced into a flask, mixing is carried out for 5 min, 4 ml of aqueous acid solution (4 g+20 ml) are then added, 1.2 g of quinacridone are then added, stirring is allowed to take place for 15 min, including 3 subjections to ultrasound following these 15 min, the mixture (3 ml of butoxy+0.05 g of PEG) is introduced, 2 further subjections to ultrasound are then carried out and, finally, the sol is matured for 4 h before deposition.

Drying 200° C. 5° C./min.

An alternative to the gradual drying is to carry out a first stationary phase of one hour at 35° C. before drying at 150° C. for 1 hour.

During such an example, an exceptional barrier effect with a hydrolytic resistance of 1.4 is obtained, for example (extraction in the autoclave at 121° C. for 1 hour), to be compared with the hydrolytic resistance of 5.7 of the coating-free bare glass.

Likewise, a sol-gel layer will be obtained which is completely neutral, i.e. measurement of the following chemical elements Ti, Sn, Pb, Cd, Si, Ca, Al, K, Fe and Cr, by ICP after one month of contact with Eau de Cologne at 45° C., of less than 2 ppm.

Identical results are obtained for one and the same formation and composition with 3 g of pigment.

In this case, the organic compounds measured in Eau de Cologne by GC-MS are identical to those obtained in direct contact with the coating-free bare glass, that is to say without modifications (neither surfactant PEG nor pigment).

### EXAMPLE 3: PROTECTION OF AN UNDERLAYER POSITIONED ON THE SURFACE OF THE GLASS ON THE INSIDE, NOT COMPATIBLE WITH THE PRODUCTS PRESENT

Test 3 Duration 4 h (14 ml of buto, 4 ml of acid (4 g+20 ml)+45 ml of TEOS+0.1 g of PEG 1500, drying 150° C. 5° C./min—1 h.

0.1 g of PEG 1500 is dissolved in 5 ml of butoxyethanol in a beaker with stirring for 45 min. 9 ml of butoxy, 4 ml of acid (4 g ds 20) and, finally, 4 ml of TEOS are introduced into a flask and stirring is allowed to take place for 45 min. After stirring the sol for the 45 min, the 5 ml of buto+PEG 1500 are introduced therein.

Drying 150° C. 5° C./min—1 h.

### EXAMPLE 4: UV PROTECTION LAYER WITH NANOMETRIC CERIUM

Test 4 Duration 5 h (14 ml of buto+0.1 g of PEG+0.55 g of cerium and 4 ml of TEOS, 4 ml of acid (4 g+20 ml) and drying 150° C., 5° C./min—1 h. 7 ml of buto+4 ml of TEOS are introduced into a flask, stirring is carried out for 5 min, and 4 ml of acid are introduced into the reactive medium (4 g+20 ml). At the same time, 1.1 g of PEG are introduced into 7 ml of buto in a beaker, and, after dissolution, the 0.55 g of cerium is introduced. When the reactive medium (butoxy, TEOS and aqueous acid solution) has been stirred for 15 min, the mixture of surfactant (PEG) and additives is introduced into the reactive medium and then 2 further subjections to ultrasound are provided before mixing for 4 h.

### EXAMPLE 5: MIXTURE WITH TEOS AND TMS AND HEAVY PIGMENTS

Test 5 (14 ml of buto+0.2 g of PEG+200 μl of Triton+3.3 g of Iriodin+2 ml of TEOS+2 ml of TMS 4 ml of acid (4 g+20 ml) drying 150° C.

7 ml buto+2 ml of TEOS+2 ml of TMS are introduced into a flask, stirring is carried out for 5 min, 4 ml of acid are introduced into the reactive medium (4 g+20 ml), the pigments are then introduced and stirring is carried out for 15 min, including 3 subjections to ultrasound. At the same time, 0.1 g of PEG is introduced into 7 ml of buto in a beaker and then the two are mixed.

In order to assess the extreme effectiveness of the surfactant, the internal coating of a bottle, with surfactant and without surfactant, has been represented with a microscope.

Observation with a microscope of a bottle (cf. FIG. 4) prepared as follows: 14 ml of butoxyethanol/4 ml of citric acid and 4 ml of EOS and prepared as described in example 2 (when applicable) but without surfactant (no PEG), reveals blisters.

The addition of 0.1 g of PEG 1500 (dissolved in 5 ml of butoxy with stirring for 45 min), added to the mixture prepared above, makes it possible to eliminate the blisters on the surface, as in the photograph of FIG. 4B.

The hydrolytic resistance obtained for the bottles is, for its part, excellent (see above, i.e. HR=1.4), which reflects a very good barrier effect.

With 0.02 g of PEG 1500 (5 times less), the results are poorer but still acceptable.

It should be noted that the addition of a surfactant means the introduction of organic compounds which are small in size and volatile and which there is a risk of reencountering in the fragrance.

In point of fact, experience shows, as has been seen above, that that is not the situation at all.

An embodiment of a device which makes it possible to implement the invention will now be described in a nonlimiting way, with reference to FIG. 3.

Subsequently, the same reference numbers will be used to denote identical or similar elements.

FIG. 3 shows a device 22 for coating 19 at least a portion of the internal surface 17 of a receptacle 16, according to the embodiment of the invention more particularly described here.

The receptacle 16 is, for example, a parallelepipedal bottle made of glass extended, with a bottleneck or cylindrical neck C, around an axis O_{z}. It thus comprises, at one of its ends (top end), an opening 10 as a bottleneck. The opening of the bottleneck comprises a neck C with a smaller diameter than that of the receptacle or bottle.

The receptacle thus substantially forms a chamber.

The device comprises a support S of the receptacle, for example comprising a retention clamp M in the shape of a dish or of a U, the branches L of which grip the base, that is to say the bottom, of the receptacle fixed via lateral screws (not represented).

Means 23 for rotating the receptacle around its axis O_{z} at a predetermined speed V are provided which are known per se. The speed V can be unchanging or variable and regulated. More specifically, the means comprise, for example, a rotating rod for driving the support which extends along the axis O_{z} and a motor for driving in a way known per se.

Means 24 for insertion/extraction (arrow 25) of a spraying tool or nozzle 26 inside the receptacle are mounted on a frame B, as dot-and-dash lines in the figure, on the side of the bottleneck of the receptacle 16.

The nozzle 26 comprises a longitudinal shaft or tube 27 connected, at its end 28, to the insertion means 24 comprising an actuator 23 for longitudinal displacement, such as a jack.

The action of the jack, which is integral with the nozzle 26, relocates the latter from an initial position external to the receptacle 13 to a position of operation internal to the receptacle along the axis O_{z}.

It thus makes possible a gradual descent, continuous or stepwise, of the tool for application of the coating solution (gel in formation) to the internal surface of the receptacle.

A sequence of points or lines with times and speeds adjusted in order to match the shape of the bottle can be employed in addition to and/or as replacement for the rotational movements.

The nozzle brings about vaporization 30 along a predetermined solid angle α for dispersion which depends on the ejection rate and pressure controlled in a way known per se.

The tube is connected, at its opposite end, to a system 31 for dispensing a liquid coating solution to be sprayed comprising means 32 for feeding with liquid or substantially liquid solution 33 in order to make possible the spraying, at a predetermined flow rate D.

The system 31 thus comprises a tank 34 for storage of said liquid and means 35 for moving the liquid (metering pump) arranged in order to regulate the flow rate D of the liquid via a calculator 36 and also controls the other actuators employed in the device.

The tank comprises, in its bottom, a mixing means, for example a stirrer (not represented).

The coating gel is the curable liquid coating material obtained by the sol-gel process described above.

The device also comprises means 37 for heating the receptacle 13 known per se which make possible the rise in the temperature of a part of the internal surface of the receptacle up to a predetermined temperature threshold.

More specifically, the heating of the internal surface is carried out, for example, by direct radiation from heating resistors 38 positioned outside the receptacle or by diffusion around the wall of the receptacle positioned in contact, for example, with a heating muffle (not represented).

In one embodiment, the receptacle and the resistor are substantially confined in one and the same chamber so as to form an oven for homogeneous heating of the receptacle.

The device also comprises a computer or automaton 39 for digital control comprising the calculator 36.

These are connected via a data bus 40 and in a way known per se to the actuators of the device, namely to those of the retention clamp of the receptacle, that is to say of the motor for driving in rotation, to those of the means 24 for insertion of the nozzle 26 into the receptacle (jack), the stirrer, and also to those of the means 35 for moving/feeding with liquid (pump, valve, nozzle) and heating means 37 (electrical resistors).

The calculator 36 is arranged in order to calculate, from the different set points imposed, a law for controlling each of the actuators in a way known per se.

As is obvious and as also results from the above, the present invention is not limited to the embodiments more particularly described. On the contrary, it encompasses all the alternative forms thereof and in particular those where the device implementing the process is different.

The application can thus and for example be carried out by lettering or stamp.

The principle here is to use a stamp in the form of a letter or pattern made of rubber (sufficiently small to be introduced into the neck of the bottle) topped/soaked with colored sol-gel and then introduced at the end of a shaft (automated/articulated subsequently) into the bottle before being applied to the surface of the glass. The stamp is subsequently taken out again from the bottle. The sol-gel is subsequently dried normally, as described above.

The application of a layer which is reactive toward UV radiation to the internal surface, followed by exposure, can also be the process used. Use is then made of a gelatin with ammonium dichromate or diazidostilbene, for example, as additional additive, reactive pigments being added to the sol-gel.

The reactive pigments are added directly to the sol-gel, a negative is adhesively bonded to the external surface of the bottle and then a strong UV light is applied through the negative in order to develop the image; the excess is washed off before drying.

It is also possible to apply the reactive layer as above and then the transparent (or colored) sol-gel is applied as internal protective surface for the product present.

Another embodiment uses printing pins.

In this instance, the principle is as follows:

One of the pin-shaped printing valves is introduced via the neck. Control of the valve makes it possible to produce fine drops close to the interior surface (inkjet type), and thus to draw a pattern is possible by controlling the relative movement of the pin with respect to the surface and also the ejection of the drop. These pins are shape-memory pins; they can be curved in order to approach internal surfaces.

It is also possible to produce arched pins which can eject drops in a desired direction.

These valves (LeeCo) have a diameter of approximately 6 mm, being able to be completely introduced into the majority of bottles. Once introduced, these valves can be inclined (for example with a robot) in order to be able to discharge more specifically into the axis of the nozzles.

With the invention, and by using a spraying system and also an appropriate specific program, while sufficiently lowering the pressure of the spraying air, the system can thus eject droplets of greater size than in normal operation. Handling in this way makes it possible to produce a “speckled” effect never obtained to date.

The invention is not limited to the embodiments more particularly described.

It covers all the alternative forms thereof and in particular those where several precursors, for example two or three, different or not from TEOS, are used in the reaction.

1. A process for the manufacture of a neutral and barrier layer with an inorganic matrix (19) for coating the internal face (17) of a receptacle (16) suitable for containing products biocompatible with man and/or animals, in which:
a solution containing at least one solvent, water, at least one complexing molecular precursor of the family of the alkoxysilanes, at least one surfactant, at least one pigment and/or dye and citric acid as catalyst is formed (1, 2, 4, 5, 6),
the solution thus complexed is uniformly applied (12) to at least a part of the internal face of the receptacle, the solution being in the course of hydrolysis and condensation, and
the solution thus applied is dried (13) at a predetermined drying temperature in order to form, on said internal face, said barrier layer, which is opaque, translucent and/or forms a predetermined pattern, before evacuation, optional storage and filling of said receptacle with the product.

2. The process as claimed in claim 1, characterized in that, the receptacle being made of glass, the predetermined drying temperature is between 140° C. and 220° C.

3. The process as claimed in claim 1, characterized in that the solution thus applied is dried by increasing the temperature at a rate of between 3° C.·min⁻¹ and 10° C.·min⁻¹ up to the predetermined drying temperature.

4. The process as claimed in claim 1, characterized in that the receptacle is preheated to a second temperature lower than the predetermined drying temperature before application of the solution.

5. The process as claimed in claim 4, characterized in that the second temperature is between 70° C. and 90° C.

6. The process as claimed in claim 1, characterized in that the drying at a predetermined drying temperature comprises a first stage of predrying at a third temperature lower than the drying temperature for a predetermined time and a second stage of drying at the predetermined temperature.

7. The process as claimed in claim 6, characterized in that the third drying temperature is between 20° C. and 50° C.

8. The process as claimed in claim 1, characterized in that the molecular precursor is taken from tetraethyl orthosilicate and trimethoxymethylsilane.

9. The process as claimed in claim 1, characterized in that the solvent comprises butoxyethanol and/or ethanol.

10. The process as claimed in claim 1, characterized in that the pigment is taken from metal oxides comprising cobalt and titanium, metal oxides comprising copper and chromium, or photochromic pigments and/or the dye is taken from the families of compounds comprising, alone or in combination, Pyrisma™, Iriodin™, quinacridone, phthalocyanine, quinophthalone and/or the compounds formed of a layer of aluminum and/or its oxides, said layer being itself coated with a layer of silicon oxide.

11. The process as claimed in claim 1, characterized in that compounds taken from the families comprising colloidal nanosilver particles and/or titanium oxides and/or cerium oxides and/or carbon black and/or polydimethylsiloxane are added to the solution before application to the internal face of the receptacle.

12. The process as claimed in claim 1, characterized in that the solution is formed by mixing the solvent and the pigment and/or dye and the mixture obtained is exposed to a mechanical ultrasound wave for a predetermined time before introduction into the mixture of the molecular precursor.

13. The process as claimed in claim 1, characterized in that, before application of the solution to the internal face of the receptacle, the extractable substances are extracted beforehand from said internal face by treatment in an oven in a humid atmosphere containing molecules of sodium chloride and/or of calcium gluconate dissolved in water in proportions not exceeding those which make possible complete dissolution of said molecules.

14. The process as claimed in claim 1, characterized in that the surfactant is taken from cetrimonium bromide, anionic surfactants or sodium lauryl sulfate and/or silicone is added.

15. The process as claimed in claim 14, characterized in that the surfactant is taken from polyethylene glycols with a molar mass of between 1000 and 2000 g·mol⁻¹, polyethylene glycol tert-octylphenyl ether, polyethylene glycol, polyethylene glycol p-(1,1,3,3-tetramethyl-butyl)phenyl ether and/or the silicone is polydimethylsiloxane.

16. A receptacle (16) made of glass appropriate for containing products biocompatible with man and/or animals comprising an internal surface (17), characterized in that said internal surface (17) is covered, over at least a part, with a layer of solidified inorganic coating matrix (19) obtained by the process as claimed in any one of the preceding claims, said coating layer (19) forming a matrix arranged in order to produce a physicochemical barrier.
